(19) United States
(12) Patent Application Publication
(10) Pub. No.: US 2013/0159847 A1
(43) Pub. Date: Jun. 20, 2013

(54) Dynamic Personal Dictionaries for Enhanced Collaboration

(71) Applicants: Christine A. Banke, Skaneateles, NY (US); William S. Carter, Round Rock, TX (US); Pawan Khera, Sewickley, PA (US); James R. Kraemer, Santa Fe, NM (US); Elizabeth V. Woodward, Cedar Park, TX (US)

(72) Inventors: Christine A. Banke, Skaneateles, NY (US); William S. Carter, Round Rock, TX (US); Pawan Khera, Sewickley, PA (US); James R. Kraemer, Santa Fe, NM (US); Elizabeth V. Woodward, Cedar Park, TX (US)

(73) Assignee: International Business Machines Corporation, Armonk, NY (US)

(21) Appl. No.: 13/325,183

(22) Filed: Dec. 14, 2011

(51) Int. Cl. G06F 17/21; G06F 15/16

(52) U.S. Cl. 715/259

(57) ABSTRACT

A mechanism is provided for utilizing a dynamic personal dictionary in enhanced collaboration. A comparison is performed for each portion of entered text of the electronic communication with text identified in the dynamic personal dictionary. Responsive to a portion of the entered text matching an entry in the dynamic personal dictionary, the portion of the entered text is marked with an identifier, the identifier indicating that the portion of the entered text has an associated context definition. The electronic communication is then sent to a set of client devices with a set of marked text portions and associated identifiers.

The present application relates generally to an improved data processing apparatus and method and more specifically to mechanisms for dynamic personal dictionaries for enhanced collaboration,

Collaboration is a recursive process where two or more people or organizations communicate together to realize a shared objective. Much of today's collaboration is performed using collaborative software designed to help people involved in a common task achieve a given objective. The design intent of collaborative software is to transform the way documents and rich media is shared to enable more effective collaboration. Collaborative software helps facilitate action-oriented groups by providing tools that aid communication, collaboration, and the process of problem solving. Additionally, collaborative software may support project management functions, such as task assignments, time-managing deadlines, and shared calendars. The artifacts, the tangible evidence of the problem solving process, and the final outcome of the collaborative effort, require documentation and may involve archiving project plans, deadlines and deliverables. Understanding the differences in human interactions is necessary to ensure that appropriate technologies are employed to meet interaction needs.

One issue with current collaborative systems is the lack of detail with regard to the context of the communication taking place. That is, during a collaborative session, the level of knowledge of the various participants in the collaborative session regarding the subject at hand may vary widely. For example, if a collaborative session is ongoing for a new piece of software and the acronym DNS is used, then a software development participant may recognize the DNS acronym to mean Domain Name System, while a speech pathology participant for whom the software is being developed may recognize the DNS acronym to mean Dragon Naturally Speaking. As another example, if an international collaborative session is ongoing for management of a project and the term “Scrum” is used, then a project management participant may recognize the “Scrum” term to mean an agile project management framework, while European participant, who is an avid fan of rugby, may take the “Scrum” term to mean a rugby event. Therefore, not having a common understanding of the meanings of words, acronyms, or the like, may result in confusion, misinformation, and extra effort to get to a common understanding.

### SUMMARY

In one illustrative embodiment, a method, in a data processing system, is provided for utilizing a dynamic personal dictionary in enhanced collaboration. The illustrative embodiment compares each portion of entered text of the electronic communication with text identified in the dynamic personal dictionary. The illustrative embodiment marks the portion of the entered text with an identifier in response to a portion of the entered text matching an entry in the dynamic personal dictionary. In the illustrative embodiment the identifier indicates that the portion of the entered text has an associated context definition. The illustrative embodiment sends the electronic communication to a set of client devices with a set of marked text portions and associated identifiers.

In other illustrative embodiments, a computer program product comprising a computer useable or readable medium having a computer readable program is provided. The computer readable program, when executed on a computing device, causes the computing device to perform various ones of, and combinations of the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 depicts a functional block diagram of a dynamic personal dictionary mechanism for use in collaborative sessions in accordance with an illustrative embodiment;

FIG. 4 depicts an example of a generation and reception of an electronic communication in accordance with an illustrative embodiment;

FIG. 5 depicts a flow diagram of the operation of generating a dynamic personal dictionary for use in a collaborative session in accordance with an illustrative embodiment;

FIG. 6 depicts a flow diagram of the operation of transmitting an electronic communication using a dynamic personal dictionary in a collaborative session in accordance with an illustrative embodiment; and

FIG. 7 depicts a flow diagram of the operation of receiving an electronic communication using a dynamic personal dictionary in a collaborative session in accordance with an illustrative embodiment.

### DETAILED DESCRIPTION

As discussed previously, one issue with current collaborative systems is the lack of detail with regard to the context of the communication taking place. That is, during a collaborative session, the level of knowledge of the various participants in the collaborative session regarding the subject at hand may vary widely. Therefore, not having a common understanding of the meanings of words, acronyms, or the like, may result in confusion, misinformation, and extra effort to get to a common understanding. Thus, the illustrative embodiments provide a mechanism for creating and utilizing personal dictionaries that map words, acronyms, or the like, to a reasonable definition for the word, acronym, or the like, based on analysis of participant's electronic device and for providing other participants with the ability to obtain another participant's intended meaning by accessing that participant's personal dictionary.

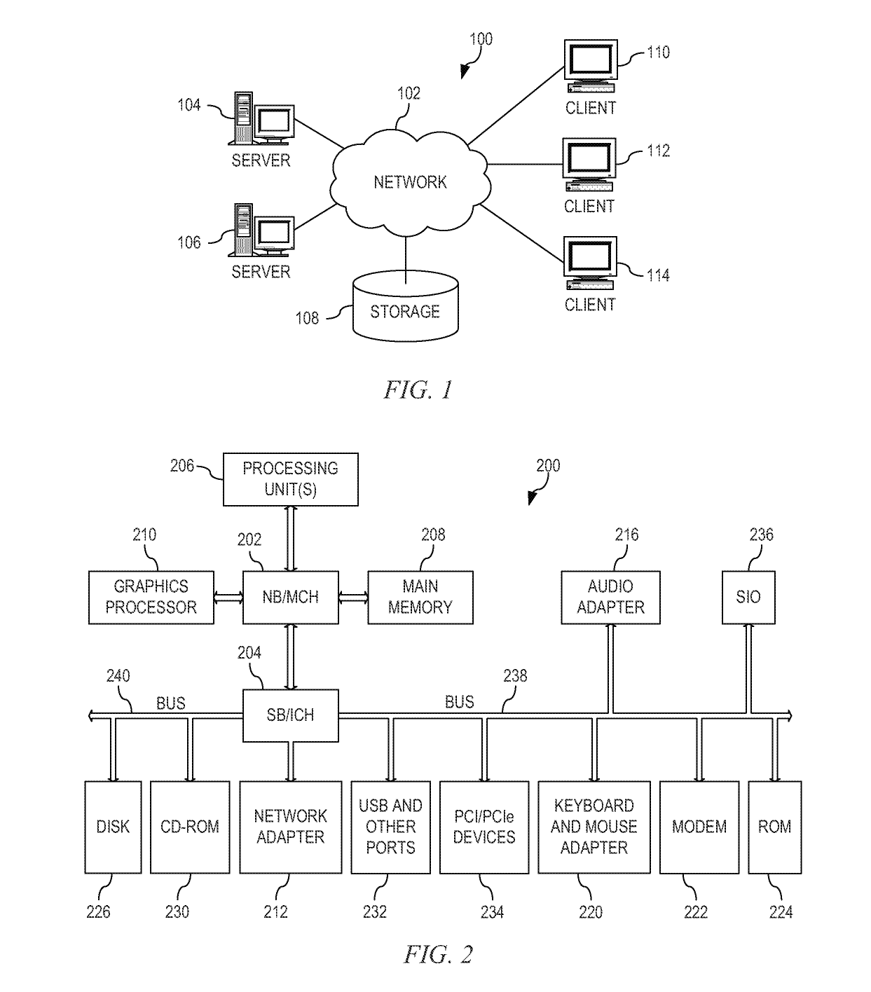

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 it should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

Again, in order to have a common understanding of the meanings of text, such as words, acronyms, or the like, in a collaborative system, the illustrative embodiments provide a mechanism for creating and utilizing personal dictionaries that map the text to a reasonable definition for the word, acronym, or the like, based on analysis of participant's electronic device and for providing other participants with the ability to obtain another participant's intended meaning by accessing that participant's personal dictionary.

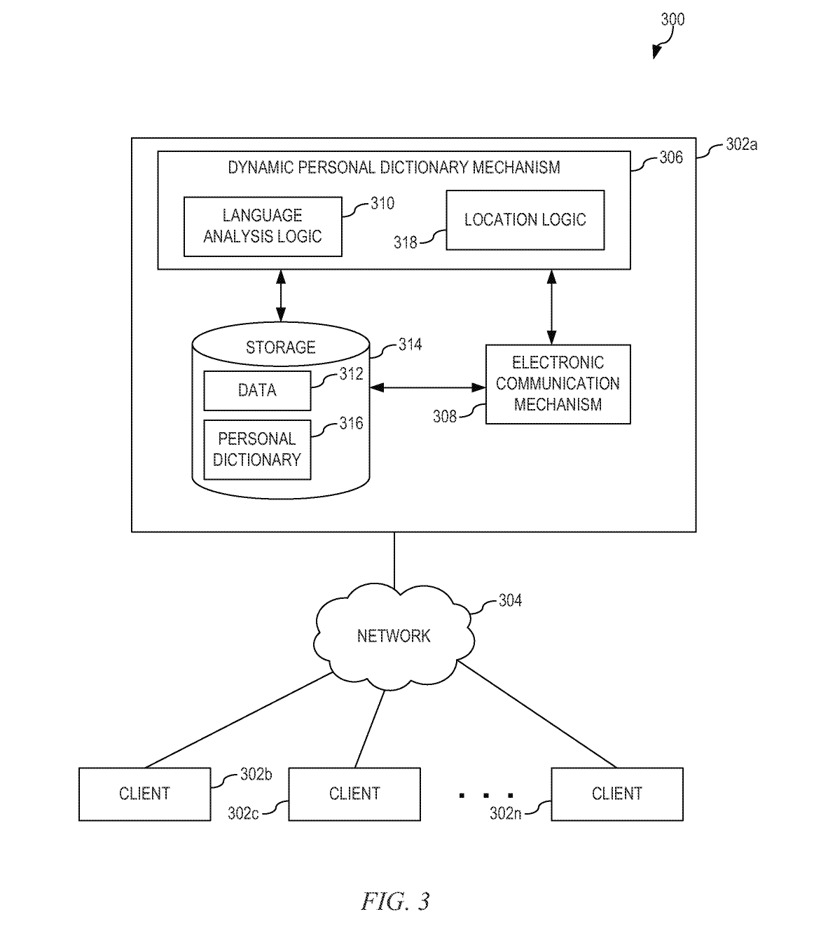

FIG. 3 depicts a functional block diagram of a dynamic personal dictionary mechanism for use in collaborative sessions in accordance with an illustrative embodiment. Each of client devices 302a, 302b, 302c, . . . , 302n, which are coupled together via network 304 in distributed data processing system 300, comprise dynamic personal dictionary mechanism 306, which may be a sub-mechanism of electronic communication mechanism 308, such as an electronic mail system, instant messaging system, chat, web page, log, social network, or the like, or dynamic personal dictionary mechanism 306 may be stand alone logic used in conjunction with electronic communication mechanism 308.

Dynamic personal dictionary mechanism 306 comprises language analysis logic 310 that analyzes a user's electronic presence on the respective one of client devices 302a, 302b, 302c, . . . , 302n. Language analysis logic 310 analyzes data 312 stored in storage 314 on the client device, such as, files, forum participation, blogs, social network activity, or the like, to determine a set of contexts or domains for the user. That is, language analysis logic 310 performs a search of the user's client device to determine a frequency of text, such as words, acronyms, or the like, used by the user. Language analysis logic 310 then performs a text association in order to identify a context for the use of each piece of text. For example, if language analysis logic 310 identifies text on the client device such as the words “scrum”, “software”, and “development”, then language analysis logic 310 would determine the definition of scrum to be an agile project management framework rather than a rugby event and group the “scrum” text into a “project management” category. Thus, after analyzing the users client device, language analysis logic 310 generates a set of contexts, such as “software development,” “project management,” “cooking,” “sports,” “woodworking”, or the like, indicating the determined interests of the user whether the interest be related to work, hobbies, sports, or the like. Based on the determined contexts, language analysis logic 310 then groups infrequent or obscure text from the client device into one of the set of contexts, thereby creating personal dictionary 316 on storage 314 that maps a context definition most likely to be meant by the user to the infrequent or obscure text.

When the user of, for example client device 302a, communicates with another user of for example client device 302c, using electronic communication mechanism 308, electronic communication mechanism 308 marks any text within the electronic communication for which the context definition exists in personal dictionary 316. That is, electronic communication mechanism 308 marks any word, acronym, or the like, that exists in personal dictionary 316 and is used in the electronic communication, such as an electronic mail, instant message, chat entry, web page posting, blog posting, social network posting, or the like, with an identifier, such as highlighting the text, bolding the text, italicizing the text, or some other way of identifying the text as potentially having a different meaning.

Events may occur where a user has interests that may cause text to be grouped into multiple contexts, for example, if a user has interests in both project management and rugby, then the term “scrum” may be grouped into both “project management” and “sports.” If such an event occurs, then, while the user is composing an electronic communication, electronic communication mechanism 308 may employ language analysis logic 310 to analyze the text of the electronic communication to provide context to the use of the text that potentially has a different meaning. Language analysis logic 310 may provide a probability factor to electronic communication mechanism 308 so that electronic communication mechanism 308 may not only mark the text as previously described, but also provide a indication of the multiple context definitions to the user with probability factors identified by language analysis logic 310. Additionally, language analysis logic 310 may access other language analysis logic 310 on one or more of clients 302b, 302c, . . . , 302n participating in the electronic communication to obtain probability factors associated with the other participants use of the multiple context definitions, to further refine the probability factors indicated to the user for the multiple context definitions. Based on the indication, the user may select an intended context definition for the marked text. Further, based on the selection, language analysis logic 310 may update personal dictionary 316 in order that future analysis with similar context would increase the probability factor.

When the user of client device 302c receives the electronic communication using their electronic communication mechanism 308, their electronic communication mechanism 308 displays the text of the electronic communication with the marking of the text that potentially has a different meaning. Then, when the user selects the marked text, either by clicking on the text, mousing-over the text, or by some other selection method, electronic communication mechanism 308 presents the intended context definition of the text to the user, either in a pop-window, a side-panel, or the like, so that the receiving user clearly understands the context associated with the text. Additionally, electronic communication mechanism 308 may present one or more actual definitions of the text so that, based on the context definition, the user may readily identify the text and its actual definition. Electronic communication mechanism 308 may identify the actual definition from an electronic dictionary, such as Merriam-Webster Online, Acronym Finder, or the like.

In another embodiment, upon receiving the electronic communication and prior to displaying the electronic communication to the receiving user, electronic communication mechanism 308 associated with the receiving client device may perform a search of personal dictionary 316 associated with the receiving user for common context definitions based on preferences set by the receiving user. That is, if the acronym DNS is marked within the received electronic communication, electronic communication mechanism 308 searches the receiving user's personal dictionary 316 for a DNS entry. If electronic communication mechanism 308 identifies a DNS entry within the receiving user's personal dictionary and the context definitions match, so that both DNS context definitions identify DNS as meaning “Dragon Naturally Speaking,” then electronic communication mechanism 308 may unmark the text within the electronic communication prior to displaying the electronic communication.

In yet another embodiment, events may occur where a user is using their client device while not in the office or at home. That is, the user may be using the client device at a restaurant. When the client device is not being used in a standard environment as identified by user preferences, electronic communication mechanism 308 may employ location logic 318 to aid in analysis of text in electronic communications. That is, electronic communication mechanism 308 may use location logic 318 to provide additional context to the use of the text that potentially has a different meaning For example, if a user uses the term “salsa” in an electronic communication and location logic 318 determines that the client device is at a restaurant, then electronic communication mechanism 308 may use the location information to mark the text with an indication that use of the term “salsa” means a spicy sauce of tomatoes, onions, and hot peppers rather than popular music of Latin American origin. However, since a restaurant may also provide dancing, then electronic communication mechanism 308 may not only mark the text as previously described, but also provide an indication of the multiple context definitions to the user. Based on the indication, the user may select an intended context definition for the marked text, Further, based on the selection, language analysis logic 310 may update personal dictionary 316 in order that future use of the term “salsa” with similar location information would only provide the one context definition.

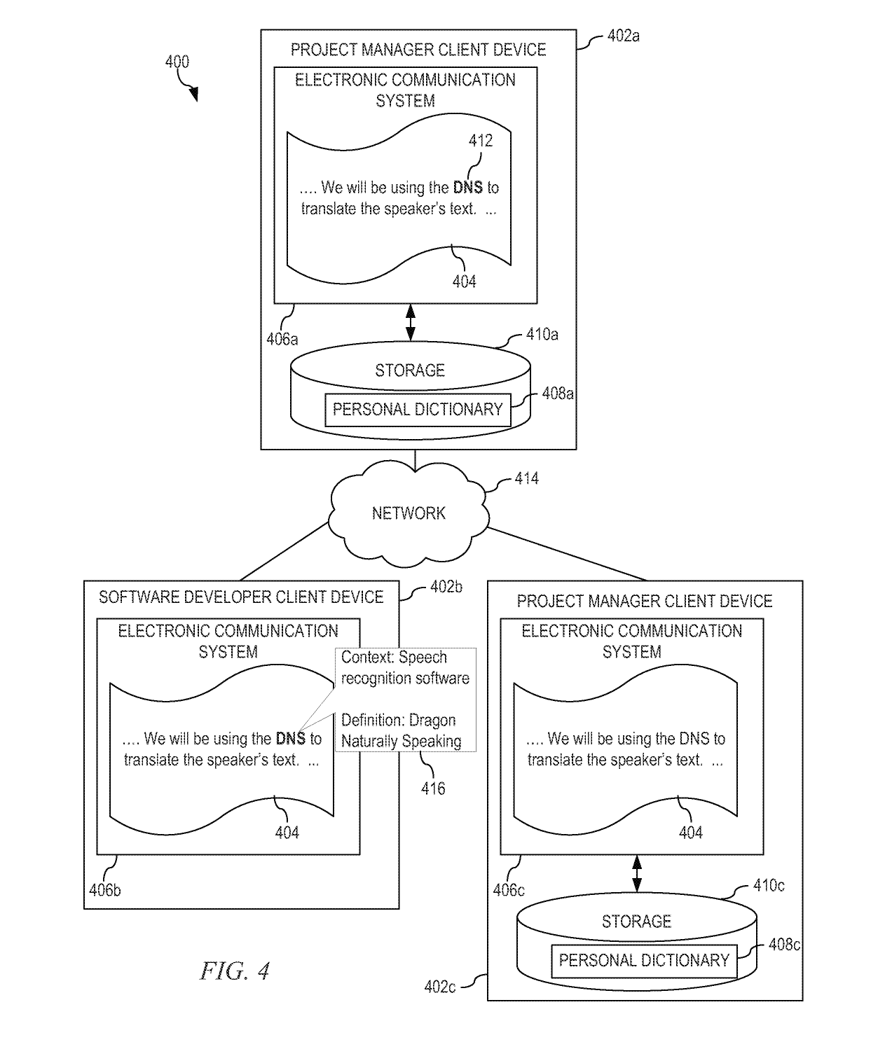

FIG. 4 depicts an example of a generation and reception of an electronic communication in accordance with an illustrative embodiment. In distributed data processing system 400 a project manager using client device 402a generates electronic communication 404 using electronic communication mechanism 406a. In generating electronic communication 404, the user uses the acronym “DNS” which appears in personal dictionary 408a on storage 410a to have a context definition of Dragon Naturally Speaking. Electronic communication mechanism 406a then marks the DNS text in electronic communication 404 with indicator 412 as having an intended context definition.

When electronic communication 404 is sent by the user of client device 402a over network 414 it is received by a software developer using client device 402b and a speech pathologist using client device 402c. In client device 402b, electronic communication mechanism 406b displays electronic communication 404 such that the “DNS” text is identified as having a context definition, When the user of client device 402b performs a mouse-over of the identified text, electronic communication mechanism 406b may present pop-up display 416 that indicates that the term “DNS” with a contextual definition of speech recognition software as well as an actual definition of Dragon Naturally Speaking.

In client device 402c, electronic communication mechanism 406c may first search personal dictionary 408c on storage 410c to determine whether a personal dictionary 408c comprises an entry for the DNS text. If electronic communication mechanism 406c identifies a DNS entry within personal dictionary 408c and the context definitions match, so that both DNS context definitions identify DNS as meaning “Dragon Naturally Speaking,” then electronic communication mechanism 406c unmarks the DNS text within electronic communication 404 prior to displaying electronic communication 404.

Thus, a dynamic personal dictionary mechanism is provided for creating and utilizing personal dictionaries that map the text to a reasonable definition for the word, acronym, or the like, based on analysis of participant's electronic device and for providing other participants with the ability to obtain another participant's intended meaning by accessing that participant's personal dictionary.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) Or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

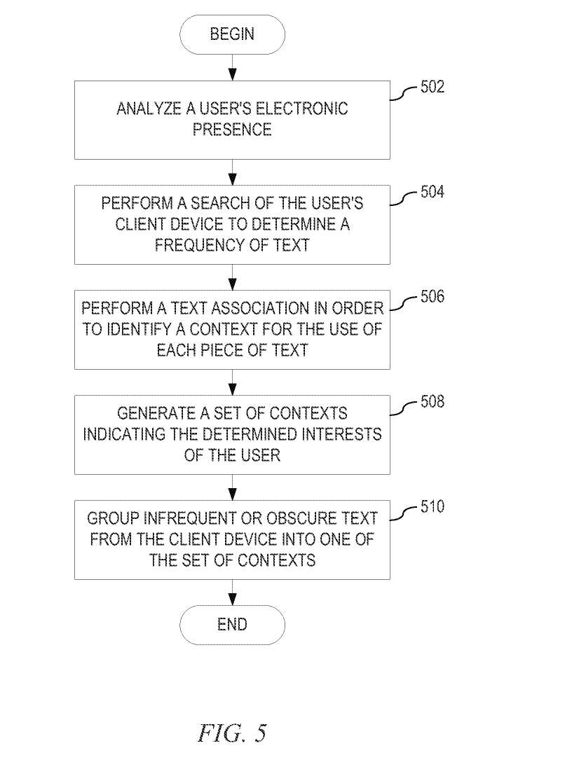

FIG. 5 depicts a flow diagram of the operation of generating a dynamic personal dictionary for use in a collaborative session in accordance with an illustrative embodiment. As the operation begins, language analysis logic within the dynamic personal dictionary mechanism analyzes a user's electronic presence that comprises data such as files, forum participation, blogs, social network activity, or the like (step 502). Based on the analysis, the language analysis logic performs a search of the user's client device to determine a frequency of text, such as words, acronyms, or the like, used by the user (step 504). The language analysis logic then performs a text association in order to identify a context for the use of each piece of text (step 506). After analyzing the user's client device, the language analysis logic generates a set of contexts indicating the determined interests of the user (step 508). Based on the determined contexts, the language analysis logic groups infrequent or obscure text from the client device into one of the set of contexts, thereby creating a personal dictionary that maps a context definition most likely to be meant by the user to the infrequent or obscure text (step 510), with the operation ending thereafter.

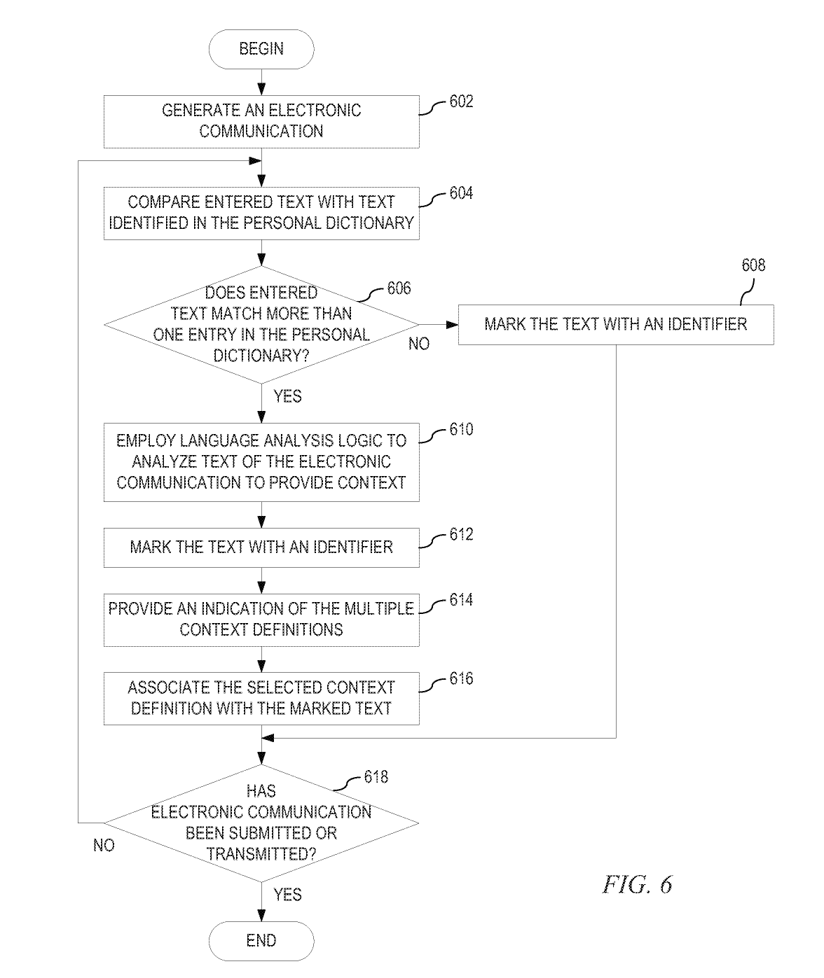

FIG. 6 depicts a flow diagram of the operation of transmitting an electronic communication using a dynamic personal dictionary in a collaborative session in accordance with an illustrative embodiment. As the operation begins, a user generates an electronic communication (step 602). As the user enters text into the electronic communication, such as by typing text, using automatic speech recognition, or the like, an electronic communication mechanism compares the entered text with text identified in the personal dictionary (step 604). If the entered text matches text in the personal dictionary, the electronic communication mechanism determines whether the entered text matches more than one entry in the personal dictionary (step 606). If at step 606 there is only one match, then the electronic communication mechanism marks the entered text with an identifier, such as highlighting the text, bolding the text, italicizing the text, or some other way of identifying the text as potentially having a different meaning (step 608).

If at step 606 there is more than one match, then the electronic communication mechanism employs language analysis logic to analyze the entered text of the electronic communication to provide context to the use of the entered text that potentially has a different meaning (step 610). Based on the analysis from the language analysis logic, the electronic communication mechanism marks the entered text with an identifier (step 612) and provides an indication of the multiple context definitions to the user with probability factors identified by the language analysis logic (step 614). Once the user selects an intended context definition for the marked text, the electronic communication mechanism associates the selected context definition with the marked text (step 616). If the user fails to indicate a selection of one if the multiple context definitions, the electronic communication mechanism may insert one of the multiple context definitions based upon a predefined setting, such as inserting the context definition with the highest probability, inserting the context definition used most frequently, or the like. From step 616 or step 608, the operation continues by returning to step 604 until the user has submitted or transmitted the electronic communication (step 618) at which time the operation ends.

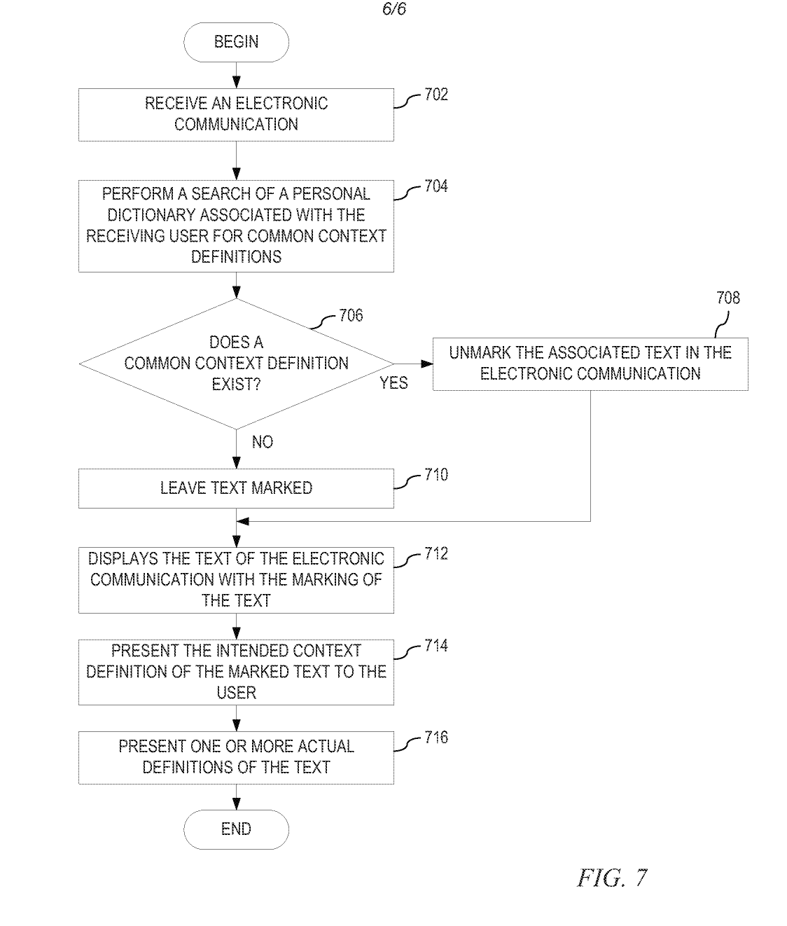

FIG. 7 depicts a flow diagram of the operation of receiving an electronic communication using a dynamic personal dictionary in a collaborative session in accordance with an illustrative embodiment. As the operation begins, a user of a client device receives an electronic communication (step 702). An electronic communication mechanism in the client device performs a search of a personal dictionary associated with the receiving user for common context definitions based on preferences set by the receiving user (step 704). The electronic communication mechanism then determines whether a common context definition exists associated with one or more of the marked text entries in the electronic communication (step 706). If at step 706 text marked in the received electronic communication is identified within the personal dictionary and the context definitions match, then the electronic communication mechanism unmarks the associated text in the electronic communication (step 708). However, if at step 706 text marked in the received electronic communication is not within the personal dictionary or if the text is within the personal dictionary but the context definitions do not match, then electronic communication mechanism leaves the text marked (step 710).

From step 708 or 710, the electronic communication mechanism then displays the text of the electronic communication with the marking of the text that potentially has a different meaning (step 712). When the receiving user selects the marked text, either by clicking on the text, mousing-over the text, or by some other selection method, the electronic communication mechanism presents the intended context definition of the marked text to the user, either in a pop-window, a side-panel, or the like, so that the receiving user clearly understands the context associated with the text (step 714). Additionally, the electronic communication mechanism presents one or more actual definitions of the text so that, based on the context definition, the user may readily identify the text and its actual definition (step 716), with the operation ending thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions fix implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for creating and utilizing personal dictionaries that map words, acronyms, or the like, to a. reasonable definition for the word, acronym, or the like, based on analysis of participant's electronic device and for providing other participants with the ability to obtain another participant's intended meaning by accessing that participant's personal dictionary.

As noted above, it should be appreciated that the illustrative embodiments may take the form of an entirety hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1-9. (canceled)

10. A computer program product comprising a computer readable storage medium having a computer readable program stored therein, wherein the computer readable program, when executed on a computing device causes the computing device to:
compare each portion of entered text of the electronic communication with text identified in the dynamic personal dictionary;
responsive to a portion of the entered text matching an entry in the dynamic personal dictionary, mark the portion of the entered text with an identifier, wherein the identifier indicates that the portion of the entered text has an associated context definition; and
send the electronic communication to a set of client devices with a set of marked text portions and associated identifiers.

11. The computer program product of claim 10, wherein the computer readable program further causes the computing device to:
responsive to the portion of the entered text matching more than one entry on the dynamic personal dictionary, analyze the entire existing text of the electronic communication in order to determine a context;
mark the portion of the entered text with art identifier, wherein the identifier indicates that the portion of the entered text has an associated context definition;
provide an indication of multiple context definitions;
responsive to a selection of one of the multiple context definitions, associate the selected context definition with the marked text; and
send the electronic communication to the set of client devices with the set of marked text portions and associated identifiers.

12. The computer program product of claim 10, wherein the computer readable program further causes the computing device to:
responsive to receiving an electronic communication, display the electronic communication with the set of marked text portions; and
responsive to a user selecting one o the marked text portions, present the associated context definition associated with the one marked text portion.

13. The computer program product of claim 12, wherein the computer readable program further causes the computing device to:
present one or more actual definitions associated with the one marked text portion.

14. The computer program product of claim 10, wherein the computer readable program further causes the computing device to:
responsive to receiving an electronic communication, search a dynamic personal dictionary associated with the one client device;
responsive to identifying a personal dictionary entry and common context definition associated with one of the set of marked text portions, remove the identifier associated with the existing one marked text portion; and
display the electronic communication with marked subset of the set of marked text portions and an unmarked subset of the set of marked text portions.

15. The computer program product of claim 10, wherein the dynamic personal dictionary is generated by the computer readable program further causing the computing device to:
perform a search of a user's client device to determine a frequency of text;
perform a text association in order to identify a context for the use of each piece of text;
generate a set contexts indicating interests of the user; and
group infrequent or obscure text from the client device into one of the set of contexts, thereby creating the dynamic personal dictionary that maps a context definition to the infrequent or obscure text.

16. An apparatus, comprising:
a processor; and
a memory coupled to the processor, wherein the memory comprises instructions which, when executed by the processor, cause the processor to:
compare each portion of entered text of the electronic communication with text identified in the dynamic personal dictionary;
responsive to a portion of the entered text matching an entry in the dynamic personal dictionary, mark the portion of the entered text with an identifier, wherein the identifier indicates that the portion of the entered text has an associated context definition; and
send the electronic communication to a set of client devices with a set of marked text portions and associated identifiers.

17. The apparatus of claim 16, wherein the instructions further cause the computing device to:
responsive to the portion of the entered text matching more than one entry on the dynamic personal dictionary, analyze the entire existing text of the electronic communication in order to determine a context;
mark the portion of the entered text with an identifier, wherein the identifier indicates that the portion of the entered text has an associated context definition;
provide an indication of multiple context definitions;
responsive to a selection of one of the multiple context definitions, associate the selected context definition with the marked text; and
send the electronic communication to the set of client devices with the set of marked text portions and associated identifiers.

18. The apparatus of claim 16, wherein the instructions further cause the computing device to:
responsive to receiving an electronic communication, display the electronic communication with the set of marked text portions; and
responsive to a user selecting one of the marked text portions, present the associated context definition associated with the one marked text portion.

19. The apparatus of claim 18, wherein the instructions further cause the computing device to:
present one or more actual definitions associated with the one marked text portion.

20. The apparatus of claim 16, wherein the instructions further cause the computing device to:
responsive to receiving an electronic communication, search a dynamic personal dictionary associated with the one client device;
responsive to identifying a personal dictionary entry and common context definition associated with one of the set of marked text portions, remove the identifier associated with the existing one marked text portion; and
display the electronic communication with marked subset of the set of marked text portions and an unmarked subset of the set of marked text portions.

21. The computer program product of claim 11, wherein the indication of multiple context definitions further comprises a probability factor associated with each of the multiple context definitions.

22. The computer program product of claim 21, wherein each probability factor indicates a probability that a context definition is associated with the electronic communication based on the analysis of the entire existing text of the electronic communication.

23. The computer program product of claim 21, wherein each probability factor indicates a probability that a context definition is associated with the electronic communication based on the analysis of a participants use of the portion of the entered text.

24. The apparatus of claim 17, wherein the indication of multiple context definitions further comprises a probability factor associated with each of the multiple context definitions.

25. The apparatus of claim 24, wherein each probability factor indicates a probability that a context definition is associated with the electronic communication based on the analysis of the entire existing text of the electronic communication.

26. The apparatus of claim 24, wherein each probability factor indicates a probability that a context definition is associated with the electronic communication based on the analysis of a participants use of the portion of the entered text.

27. The apparatus of claim 16, wherein the dynamic personal dictionary is generated by the instructions further causing the processor to:
perform a search of a user's client device to determine a frequency of text;
perform a text association in order to identify a context for the use of each piece text;
generate a set of contexts indicating interests of the user; and
group infrequent or obscure text from the client device into one of the set of contexts, thereby creating the dynamic personal dictionary that maps a context definition to the infrequent or obscure text.
